(19) United States
(12) Patent Application Publication
(10) Pub. No.: US 2009/0300171 A1
(43) Pub. Date: Dec. 3, 2009

(54) REMOTELY MANAGED TEST AND MONITORING DEVICE FUNCTIONALITY WITH MULTI-FACETED COMMUNICATION CAPABILITY

(76) Inventors: William H. Bhame, Madison, GA (US); James M. O'Brien, Marietta, GA (US)

Correspondence Address: Adorno & Yoss, LLC, 1349 West Peachtree Street, NE, Suite 1500, Atlanta, GA, 30309, US

(21) Appl. No.: 12/255,736

(22) Filed: Oct. 22, 2008

Related U.S. Application Data
(60) Provisional application No. 61/130,128, filed on May 28, 2008.

(51) Int. Cl. G06F 15/173; G06F 15/177; G06F 11/00; G08B 21/00

(52) U.S. Cl. 709/224; 702/188; 340/540

(57) ABSTRACT

A routing/hub functionality software and associated hardware platforms are provided for managing test and monitoring devices such as portable test and monitoring devices in healthcare. The routing/hub functionality software can be executed on custom or generic computing platforms and interface through a variety of communication means with multiple peripheral devices collecting data. The software may also configure those devices based on user input or input from the data management system. Collected data is provided to the data management system for actions such as analysis, reporting, and peripheral device configuration. Alerts and messages may also be provided to designated recipients directly or through the data management system based on predefined rules for collected data.

### RELATED APPLICATIONS

This application claims the benefit of U.S. Provisional Application Ser. No. 61/130,128 filed on May 28, 2008, which is hereby claimed under 35 U.S.C. §119(e). The referenced Provisional Application is incorporated herein by reference.

### BACKGROUND

With the rapid development of various electronic, mechanical, and chemical technologies test and monitoring devices have become increasingly smaller in size and larger in variety and numbers. From industrial to biomedical applications, test and monitoring devices are found in all aspects of life. Many of these devices are designed for performing a specific test/measurement and then provide the data through downloading, wired communication, wireless communication, and the like. In a particular area of interest, system designers typically put together a unique system comprising one or more test/measurement devices, a communication means, and a processing device for processing the data from the test/measurement device(s). Thus, test and measurement applications are typically specific and require custom components, installation, maintenance, and the like.

A prominent example of inefficient use of test/measurement systems is medical care. Test and monitoring is an important aspect of preventative and continuous care of patients and people at risk for certain diseases and conditions. Diabetes, high blood pressure, seizures are examples of conditions that may require regular monitoring in order to maintain patients' health. In a hospital or similar controlled environment, test and monitoring devices may be connected to a network and results processed by relatively complicated and large systems. Despite relatively small and user-friendly test and monitoring devices being available in the market today, those are typically for disconnected use by the patients who have to record the results, in some cases interpret themselves, and report to their healthcare providers. This results in relatively fractured, inefficient availability of services. Critical resources are often dramatically underutilized resulting in increased cost as well as frustration of both patients and care-providers., the use of such test and monitoring devices does not improve efficiency, cost, or quality of healthcare significantly.

On the other hand, the direction of computing today is more and more generic platforms that can be adapted to specific needs with minimal user or expert adjustments. For example, businesses are using increasingly the Internet for their communication needs, whatever those may be. The days of custom designed/installed/maintained communication networks are over. This progress toward use of generic resources such as communication networks has not sufficiently been implemented in test/measurement systems yet.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to managing one or more test and monitoring end devices through hub/routing functionality implemented on custom or generic platform devices and wired and/or wireless communication with a backbone infrastructure. The functionality may be implemented to configure, manage, and communicate with a plurality of test and monitoring end devices, collect data from those end devices, provide the data for storage and analysis to a backbone system, provide preconfigured alert messages to designated communication end devices through wired or wireless networks, and perform local actions—if necessary—through the end devices such as administration of emergency therapeutic medications.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 is a diagram illustrating an example software architecture of a system according to embodiments with external components;

FIG. 2 illustrates two example routing/hub device platforms where functionality according to embodiments may be implemented;

FIG. 3 illustrates two additional example routing/hub device platforms where functionality according to embodiments may be implemented;

FIG. 4 is a conceptual diagram illustrating an example routing/hub device communicating with data reporting and analysis repository in a medical test and monitoring application according to embodiments;

FIG. 5 illustrates example software modules for implementing routing/hub functionality according to embodiments;

FIG. 6 illustrates a networked environment where embodiments may be implemented; and

FIG. 7 is a flowchart of a process for managing test and monitoring end devices in a system according to embodiments.

### DETAILED DESCRIPTION

As briefly discussed above, functionality for managing test and monitoring devices may be implemented on custom or generic platforms and employed to gather data from those end devices, perform actions based on the gathered data such as providing alerts or messages to communication end devices, and provide the data to a reporting and analysis repository for further actions. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments are described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

Furthermore, references are made and preferred embodiments are described in conjunction with a medical test and monitoring application. However, embodiments are not limited to medical applications. A routing/hub device and functionality for managing test and monitoring end devices and an associated data reporting and analysis repository may be implemented for any type of test and monitoring application including, but not limited to, industrial applications (e.g. chemical test monitoring), security applications (e.g. home monitoring), geological monitoring applications (e.g. geologic activity monitoring), and the like, using the principles described herein.

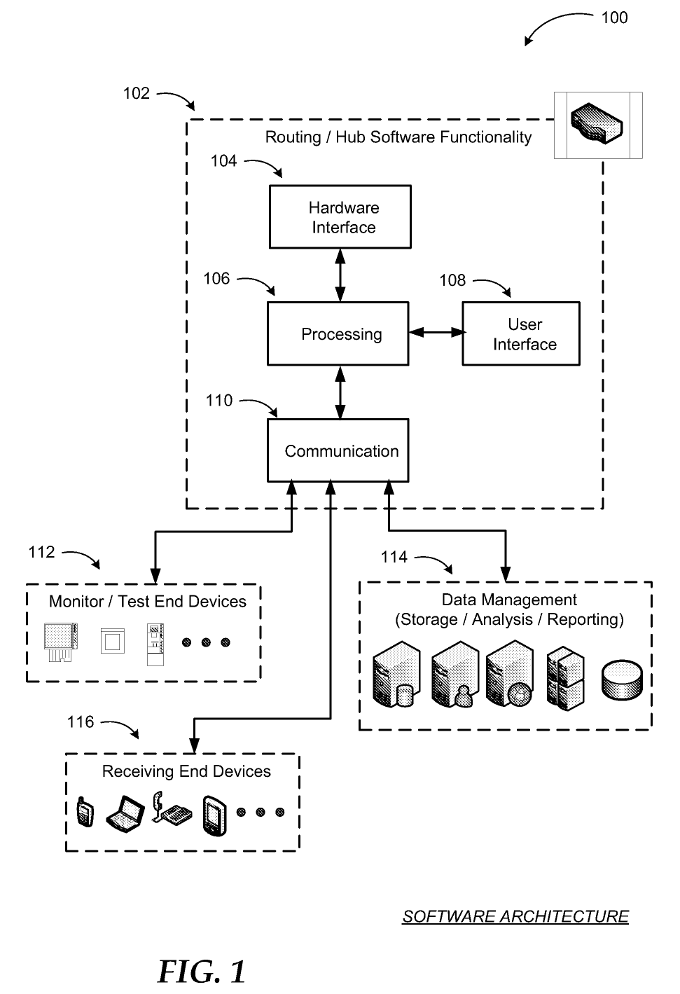

Referring to FIG. 1, diagram 100 of example software architecture of a system according to embodiments is illustrated with external components. As mentioned previously, management and routing functionality for a plurality of test and monitoring devices may be provided through custom or generic hardware platforms.

Core functionality includes interfacing with one or more test and monitoring devices, configuring them, receiving collected data, forwarding collected data to a central repository, and providing ancillary functions such as issuing alerts to predefined destinations, instructing complicated test and monitoring devices to perform function in addition to testing and/or monitoring. Since the functionality can be provided through custom or generic hardware platforms, major blocks are represented as software architecture modules. Any of the functionality and operations described herein may be distributed among the listed modules. The architecture may also be structured differently from the example structure described here with fewer or additional blocks.

Routing/hub software functionality 102 includes hardware interface module 104, processing module 106, user interface 108, and communication module 110. Hardware interface 104 provides interfacing capability to the software with routing and hub functionality with a custom or generic hardware platform. As discussed in more detail below, a custom portable device (or even a stationary device) may be used to execute the software and communicate with the test and monitoring devices as well as the central repository. Such a device may require custom communication protocols, configuration, and other operational aspects. According to some embodiments, the software may be configured with multiple hardware interfaces such that a variety of hardware platforms may be used to host the routing and hub software. For example, specific interface parameters may be installed in the software for operation on various portable computing devices.

Through communication block(s) 110, communication capability with a plurality of devices and systems over a number of communication modes is provided. Test and monitoring end devices 112 may be managed through some of these communication modes. Since each end device may have a unique (or standardized) communication interface, routing/hub software functionality 102 may be configured to accommodate a variety of physical and programmatic interfaces. These capabilities also include accommodation of various Application Programming Interfaces (APIs) for various end devices. The physical capabilities include different wired and wireless communication interfaces such as Universal Serial Bus (USB), IEEE 1394®, RJ11, RJ45, and the like for wired connections. For wireless connections, a variety of short and long range communication protocols may be employed as well. Examples of such protocols include Wireless LAN (WLAN) protocols, short range low power communication protocols, optical communication protocols, as well as any long range communication systems. Physical and programmatic communication interfaces are well known in the art and not discussed here in exhaustive detail. Embodiments may be implemented using any interface available.

According to a preferred embodiment, routing/hub software functionality 102 provides data collected from managed test and monitoring devices to data management system 114. The data management system 114 also referred to as the central repository may also be responsible for configuring the routing/hub software and its hardware platform, as well as providing reports, alerts, etc. to appropriate parties based on the collected data. On the other hand, some or all of the tasks associated with gathered data may be performed locally by the routing/hub software and its hardware platform. Communication module(s) 110 provides communication capability through the various methods described above with data management system 114 as well.

Additionally, routing/hub software functionality 102 and it hardware platform may transmit short messages, alerts, and other information to selected communication end devices 116 through communication module(s) 110. The communication end devices 116 may include any device capable of electronic communication such as cellular phones, smart phones, regular phones, computer terminals, and the like. Communication with these may be performed through any wired and wireless means as discussed above, although a long range communication mode such as over a public or private network is more likely to be employed in this communication. Of course, the communication does not have to be limited to short messages or alerts. Any amount of data may be transmitted to a target communication device.

Processing module 106 is the heart of routing/hub software functionality 102. This module maintains operational data, process collected data, configure communication and interface parameters, receive user inputs and/or remote management instructions, and perform any other associated tasks. As such processing module 106 may involve the operations of one or more processors, temporary or permanent memory modules, and other hardware components. According to some embodiments, processing module 106 may receive user input for configuration, communication, and other test and monitoring device related task instructions through a user interface on the hardware platform. Since different hardware platforms can have various physical user interfaces (keyboard, mouse, touch-screen, and the like), different user interface 108 configurations may be predefined in the routing/hub software functionality 102.

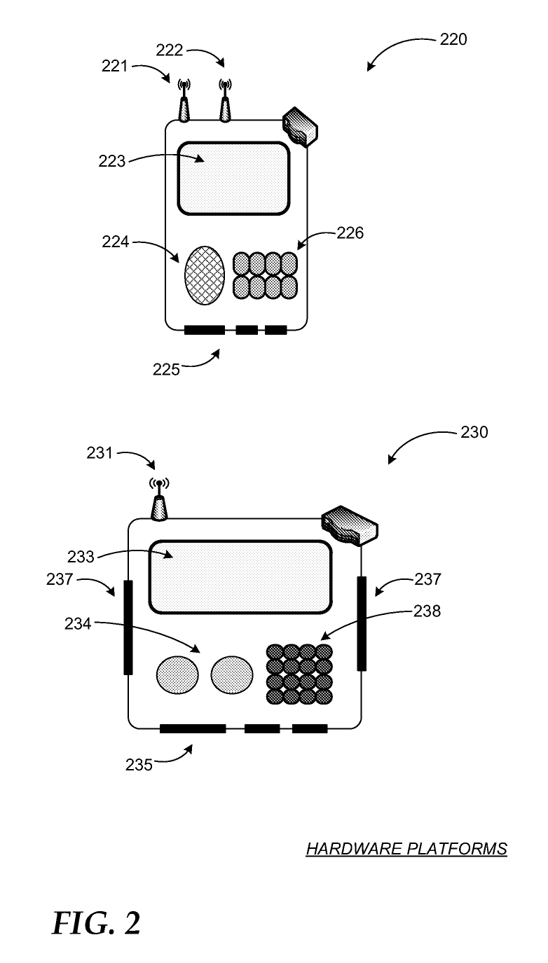

FIG. 2 illustrates two example routing/hub device platforms where functionality according to embodiments may be implemented. Devices 220 and 230 are examples of custom hardware platforms.

Custom hardware platforms are commonly used in particular industries such as chemical test and monitoring, medical care, and the like. A custom computing device may be designed considering the needs of the users and the entity providing the monitoring service for managing specific test and monitoring devices. For example, a custom device may be designed for wireless (or wired) communication with test and monitoring end devices only. Power supply and environmental aspects may be part of the custom design such as rechargeable batteries, water-tight insulation, and the like. Custom hardware platforms may include a number of optional configurations. Example aspects of such devices are described herein without constituting a limitation to a hardware platform for a routing and hub functionality software according to embodiments.

Device 220 is a handheld device with wireless communication capabilities in two or more Radio Frequency (RF) bands as illustrated by antennas 221 and 222. Device 220 also includes a display 223 for providing information to a user. Display 223 may also be a touch-sensitive display and be used as a two-way user interface enabling the user to enter input for selecting communication options, configuring devices, and similar operations.

Additional user interfaces may include, but are not limited to, a rolling ball or knob style input selector 224 and specialized keys 226. Device 220 may also include a number of wired ports 225 for communication connections (e.g. RJ-45, RS232), power input, audio output, and other purposes. As a handheld device, device 220 may be powered by one-time use or rechargeable batteries, solar cells, or other technologies. The device may include additional or fewer user interfaces and communication options.

Device 230 is a semi-portable routing/hub hardware platform such as a smart automobile console. Device 230 includes some of the same components like device 220 such as antenna 231, wired ports 235, display 233, and keys 238. The number of knob style input selectors 234 may be more than one as shown on this figure just as the number of keys may be variable too. Wireless communications in different RF bands may utilize the same antenna through different transceiver circuits. The components of device 230 may be designed and built to comply with environmental requirements for a vehicle-mount device such as more rigid temperature or shock requirements compared to a regular handheld device. Additionally, custom mounting hardware 237 may be used to provide stable positioning for the vehicle-mount routing/hub hardware platform.

Such a vehicle-mount hardware platform may not only be used in industrial (e.g. chemical) test and monitoring applications, but also in medical care. For example, patients may be given test and monitoring end devices to measure particular health conditions (e.g. blood sugar level, blood pressure, etc.) for use at home. A health care worker may visit the patients daily and during his/her visit, the routing/hub hardware platform executing the management software may automatically download collected information from the end devices and make any configuration changes to those.

Another use scenario may be in a health care facility with multiple patients, where the routing/hub hardware platform may be used as a portable device by a healthcare worker to gather collected test and monitoring data from a plurality of end devices on patients on each floor and then to upload to the central data management system. A variation of this scenario is home use with multiple patients using different test and monitoring end devices. A single routing/hub hardware platform executing management software provided by a third party service provider (e.g. a network service provider) may collect the data from each end device and upload to the central repository for processing and forwarding to appropriate healthcare providers for the patients. Such a device would enable the test and monitoring end devices to be designed as small as possible (without the burden of having long range communication circuitry), multiple end devices from various vendors to be used within the same system by implementing custom APIs, and not force the healthcare providers to have the technology know-how and maintenance cost since the system may be managed by the network service provider in the area.

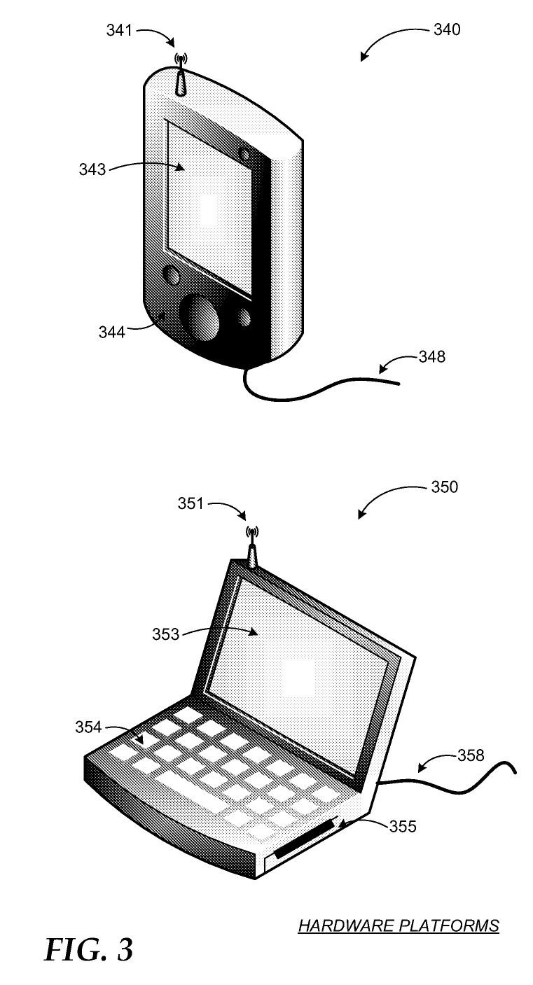

FIG. 3 illustrates two additional example routing/hub device platforms where functionality according to embodiments may be implemented. Device 340 is a Personal Digital Assistant (PDA) with communication capability. PDAs are commonly available and capable of executing a wide variety of applications. Routing/hub functionality software may be provided by the management service provider to users for uploading to their PDAs (or other generic computing devices) and manage test and monitoring end devices through the generic platform (PDA 340 in this case).

PDA 340 may include one or more antennas (341), a display 343, and one or more user interface components such as control wheel 344. In addition to wireless communication capability, PDA 340 may also include wired connection capability 348 for coupling to a communication network or individual test and monitoring end devices.

Routing/hub functionality software may include pre-packaged APIs for interfacing with a number of test and monitoring end devices. The software may also include the capability to direct a user to a website for downloading APIs for end devices that are not included in the software or for updates. Furthermore, the software may utilize existing communication software (e.g. in a PDA capable of cellular communication) to connect to the central data repository. Other interactions with existing applications on the device such as providing collected data or information associated with the collected data to a calendaring or spreadsheet application resident on the PDA, downloading personal information about a monitored patient from another application resident on the PDA, or displaying collected data through a presentation application resident on the PDA, may also be designed into the routing/hub software.

As mentioned previously, preferred embodiments are geared toward portable hardware platforms for executing routing/hub functionality. However, any type of computing device may be utilized to execute such software. Laptop computer 350 is a typical example. Many people own laptop computers today. Thus, it would be practical for a service provider to take advantage of inherent communication capabilities and processing power of laptop computers and provide the routing/hub functionality software to users for installation on a laptop. Laptop 350 with its standard user interface components (display 353, keyboard 354) and interconnectivity components (connection port 355, wired connection 358, wireless communication antenna 351) may execute the software collect data from (and configure) test and monitoring end devices, and communicate with the central repository system for uploading the collected data, receiving instructions, and the like.

Any communication between different components of a system implementing embodiments may be secure communications. For example, the data from a device executing routing/hub software to the data repository and analysis system may be encrypted for security purposes. Similarly any reports and/or alerts provided to pre-designated recipients may also be encrypted or otherwise secured. The security measures may be based on policy rules of the system, user profiles, network types, and similar aspects of a system according to embodiments.

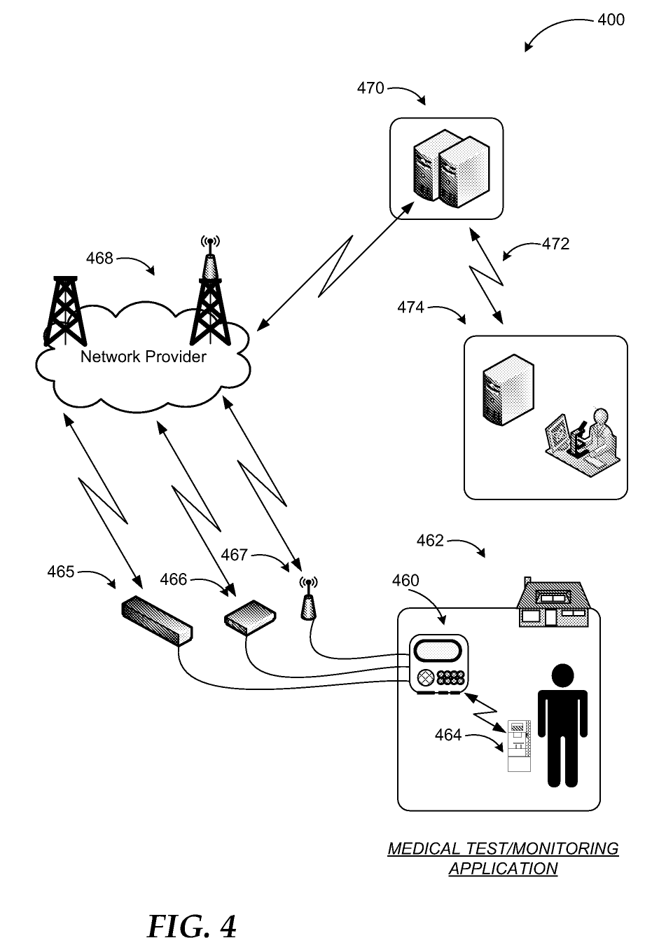

FIG. 4 is a conceptual diagram illustrating an example routing/hub device communicating with data reporting and analysis repository in a medical test and monitoring application according to embodiments.

Routing/hub functionality on hardware platform 460 may be used to manage any test and monitoring device (e.g. 464). In the example diagram 400 of FIG. 4, end device 464 is an example medical monitoring device for use at home 462 of a patient. Hardware platform 460 communicates through wired or wireless means with end device 464 gathering collected data. The software in the hardware platform 460 may then communicate with a managing service 470 through a network managed by network provider 468. The communication with the network may be through Public Switched Telephone Network (PSTN) 465, cellular network 467, or data network 466. For example, hardware platform 460 may connect through an RJ11 or RJ45 type connection to the PSTN and through this public network to the network provider's own network. Similarly, communication may be established over cellular networks, wired/wireless data networks (e.g. an enterprise network), or even a unified communications network. Unified communication networks are relatively recent systems combining data, voice, and other communication mechanisms in a user-friendly and efficient manner.

Managing service 470 may include the central repository for collected data and perform tasks such as storing the data, analyzing the data, transmitting reports based on the analysis or raw data to healthcare providers (474) or other parties, transmitting alerts to designated parties if an alert condition is met. For example, if the data indicates a particular condition of the patient being critical, local emergency services, a patient designated contact, and/or a doctor's office may be alerted through a phone call, email, text message, and the like.

The alerting functionality may also be performed directly by the routing/hub functionality software through the hardware platform 460. If an alert condition is detected, the hardware platform may send out the alert through anyone of the above described mechanisms directly to the recipients over any one of the above described networks.

Furthermore, the routing/hub functionality software through the hardware platform 460 may be configured to instruct capable end devices to perform tasks other than test and monitoring. For example, an advanced blood sugar monitoring device may also be equipped with the capability to inject the patient with insulin if the patient in shock. Thus, upon detecting the patient's condition, the managing service 470 may transmit instructions to the hardware platform, which in return may activate the insulin injection functionality of the end device.

The above described scenario is one example implementation only. A hardware platform for routing/hub functionality software may connect to one or more commercially available medical testing components utilizing one or more standard technologies such as photochemical, spectroscopic, electrochemical, or micro-needle, or other miniaturized means of in vitro or in vivo testing of bodily fluids or tissue samples such as lab-on-chip to quantify one or more metabolites in a blood, urine, saliva or interstitial fluid or body tissue sample (i.e. glucose blood testing). Various visual indicators for displaying the operational status the routing/hub device such as‘testing’, ‘transmitting’ and‘receiving’, as well as various visual/audible alarms for alerting the healthcare consumer or an associated healthcare provider to test and/or analysis results may be provided through the device. Emergency alert tools such as a 911 Call Button may be used to activate an emergency only cellular/PSTN voice channel for the immediate request of local emergency services.

Moreover, the hardware platform and the associated software may also be equipped with location detection services such as Global Positioning Service (GPS) to provide the location of the patient to healthcare/emergency service providers should the patient become incapacitated. Modules such as an accelerometer with an override/reset feature for monitoring and reporting on the consumer's ambulatory state, as well as other for facilitating improvements in current and future health care management methodologies and practices for chronic, sub-acute and acute health conditions may be implemented. Medical conditions where the user of a system as described above may be useful include blood pressure/cholesterol/heart rate monitoring, medication intake monitoring, diabetes testing, cancer, obesity, HIV, end-of-life care, and other chronic/sub-acute/acute conditions.

While the example devices, systems, and scenarios in FIGS. 1, 2, 3, and 4 have been described with specific components and features, embodiments are not limited to these components or system configurations and can be implemented with other system configuration employing fewer or additional components. Functionality of the systems enabling test and monitoring device management may also be distributed among the components of the systems differently depending on component capabilities and system configurations.

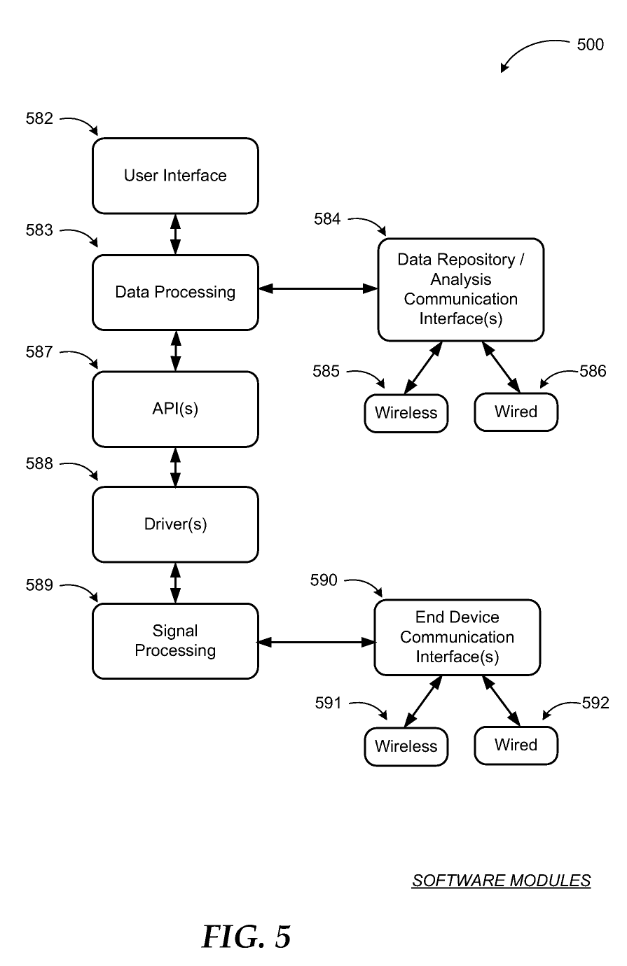

FIG. 5 illustrates example software modules for implementing routing/hub functionality according to embodiments. These modules are intended to illustrate groupings of software functionality, but do not constitute limitations on the embodiments. Functionality of the software according to embodiments (along with its hardware platform) may be grouped in other ways without departing from a scope and spirit of the present disclosure.

As shown in diagram 500, routing/hub functionality software as described herein may include a number of layers. User interface layer 582 performs tasks for operating in conjunction with the available user interface elements of the hardware platform. As discussed before, this layer may be custom for a custom hardware platform or include prepackaged user interface elements for generic computing devices. A data processing layer 583 may be used to process inputs from the user interface elements as well as from the peripheral devices and other components of the system such as the remote data management component.

Data processing layer 583 may interact with data repository/analysis communication interface(s) 584 through wired or wireless (585, 586) means receiving instructions for configuration and operations, uploading gathered test and monitoring data, and communication operations (e.g. communication protocols). As discussed earlier, preconfigured or customized APIs 587 may be stored and utilized by the routing/hub functionality software in conjunction with its hardware platform to interface with multiple test and monitoring end devices. Updates to APIs may also be performed automatically or manually as device configurations change or software is further developed. Each end device may also have its own drivers 588, which may be uploaded to the routing/hub software by the user, data management system, or other means.

At least a portion of the data transmitted to the data repository and analysis system by data processing layer 583 may be filtered. For example, the data may be subjected to a pre-analysis, and if it is determined that the data is not useful data (any number of methods may be used for this), the data may not be transmitted at all. Moreover, direct alerts from the device executing routing/hub functionality may be transmitted based on the filtering operations, which may include partial analysis of the collected data.

Data processing layer 583 may receive router/hub instructions related to one or more aspects of the router/hub device's operations. For example, a communication protocol, a data collection configuration, a data security configuration, and many other similar aspects may be instructed by the data repository and analysis system to the connected router/hub devices. The instructions may be based on policies such as templates for different types of devices, conditions monitored by the devices (e.g. medical conditions), user profiles, data recipient profiles, and the like. The instructions may be partially dependent on analysis results by the data repository and analysis system or independent from the analysis results.

In addition to receiving instructions from the data repository and analysis system, the routing/hub device may also receive additional information such as instructions associated with the monitored condition to each user, informative explanations, warnings, training material, and so on. In case of medical conditions, information with nearby healthcare providers, pharmacies, or even new prescriptions may be transmitted to the routing/hub device. The additional information may also include marketing related material such as discount coupons for required medication, equipment, informative seminars, and the like. The information received by the routing/hub devices may come from sources other than a healthcare provider or the data repository and analysis system manager for forwarding to relevant users (based on monitored condition, location, and other criteria).

Signal processing layer 589 may be used to process digital and analog signals received from other devices directly or through network communications. Such signals are received through end device communication interfaces 590 by wired or wireless means (591, 592) as exemplified in FIG. 4.

According to one embodiment, the routing/hub functionality software may be managed by a communications service provider (e.g. a cellular network provider), which can manage the APIs, long range communications, and data analysis and reporting by executing the software on a custom hardware platform or user computing device. The data analysis and reporting portion may also be performed by a third party service with the communications being facilitated by the communications service provider.

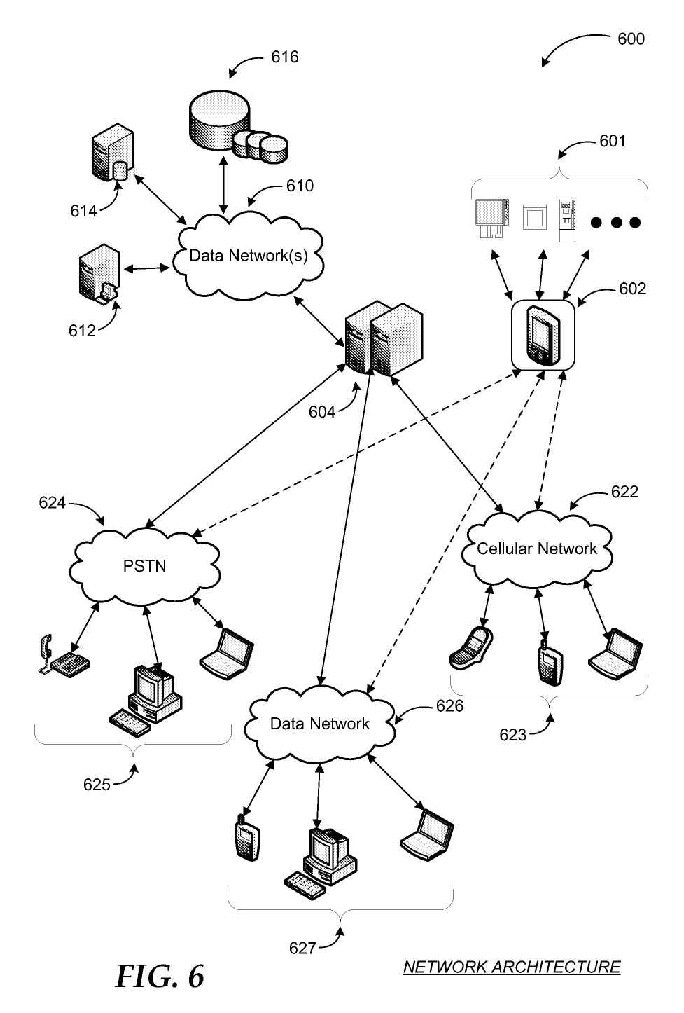

FIG. 6 is an example networked environment, where embodiments may be implemented. Test and monitoring device management as described previously may be implemented locally or in a distributed manner over a number of physical and virtual clients and servers. Such a system may typically involve one or more networks such as PSTN 624, cellular network 622, data network 626, and data network(s) 610. At least one of the systems may be implemented in un-clustered systems or clustered systems employing a number of nodes communicating over one or more networks.

A system according to embodiments may comprise any topology of servers, clients, Internet service providers, and communication media. Also, the system may have a static or dynamic topology. The term “client” may refer to a client application or a client device. A system according to embodiments may involve many more components, typical and relevant ones are discussed in conjunction with this figure.

Routing/hub functionality software managing and collecting data from a number of peripheral test and monitoring devices (601) is executed on a hardware platform 602. In response to predefined rules, routing/hub functionality software may provide messages, data, and/or alerts to communication devices such as client devices 623, 625, and 627 over cellular network 622, PSTN 624, and data network 626, respectively. Routing/hub functionality software may also provide collected data and receive configuration information from a data management service managed by server(s) 604. The data management service may be implemented in a distributed manner over one or more networks such as the networks listed above. Data management service may further include data storage facilities 616, database servers 614, communication servers 612, etc. communicating over data network(s) 610. The service may analyze the collected data and perform actions such as providing reports, alerts, etc. to recipients through client devices 623, 625, and 627. As mentioned previously, a unified communication system with one or more specialized or combination servers (not shown) for presence, routing, and other functionalities, may also be utilized.

Communication between any nodes described in the diagram 600 may include wired media such as a wired network or direct-wired connection, and wireless media such as acoustic, RF, infrared and other wireless media.

Many other configurations of computing devices, applications, data sources, and data distribution systems may be employed to implement test and monitoring device management. Furthermore, the networked environments discussed in FIG. 6 are for illustration purposes only. Embodiments are not limited to the example applications, modules, or processes.

The claimed subject matter also includes methods as discussed above. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

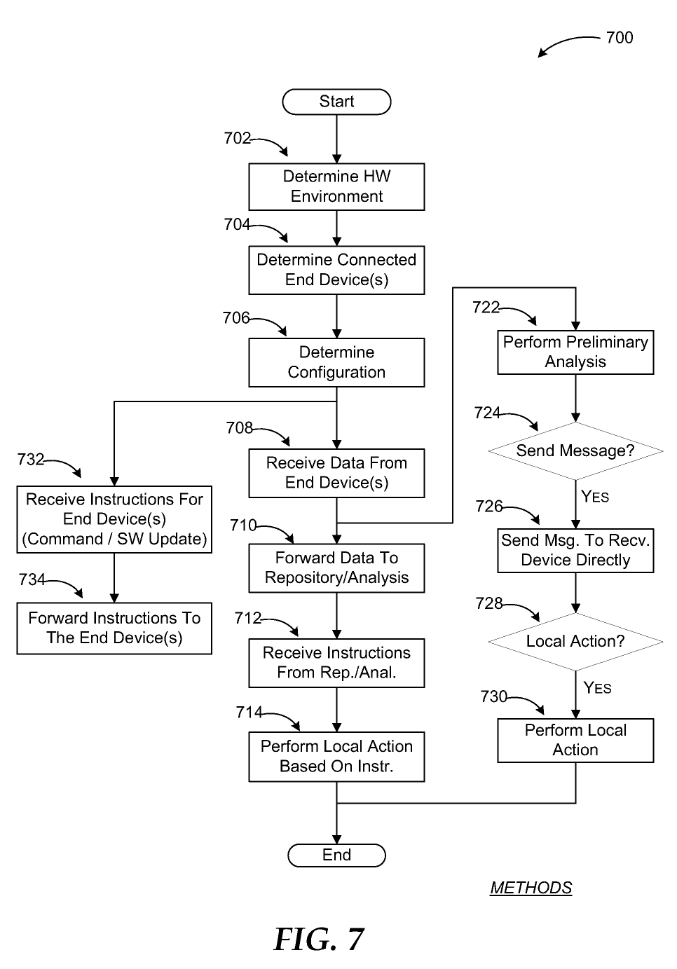

FIG. 7 is a flowchart of a process for managing test and monitoring end devices in a system according to embodiments. Many of the operations described below are optional operations that are not essential for the core operation of a system according to embodiments. They have been included for completeness and illustration of potential breadth of a system according to embodiments.

A typical operation may begin with determination of the hardware environment by the routing/hub functionality software (702). This feature may be significant in case where generic hardware platforms are used and the software provided to end users by the management service. The hardware environment may include characteristics such as memory capacity, processing power, communication capabilities, and the like. Processing then proceeds to operation 704, where connected test and monitoring end devices are determined. As discussed previously, APIs (and drivers) for standard end devices may be pre-packaged in the software. Others may have to be downloaded by the user or automatically by the software.

At next operation 706, the configuration of the end devices and the software itself is determined. This may be done by receiving instructions from the data management service or automatically by the software based on the connected end devices, hardware platform capabilities, and the like. After operation 706, processing branches to two alternative paths. According to one path, instructions may be received from the data management service for the end devices (732) such as commands or software updates for configuring the end devices. At operation 734, the received instructions are forwarded to the end devices for configuration, reconfiguration, update, performing tasks, etc.

In the alternative path, collected data is received from the test and monitoring end device(s) at operation 708. The collected data is forwarded to the data repository/analysis system at subsequent operation 710 and instructions are received from the data management service at operation 712 based on analyses of the forwarded data. Optionally, local actions such as instructing end devices to perform an action or to configure themselves may be performed in response to the received instructions at operation 714.

Alternatively, routing/hub functionality software may perform a preliminary analysis of the collected data at operation 722 following operation 708 and make a determination at decision operation 724 whether to transmit a message or not based on the analysis result. The preliminary analysis may simply be comparison of collected data to a predefined threshold (e.g. comparison of measured blood pressure to a critical threshold).

If the determination is to send the message, which may include a phone call, an email, a text message, or any other form of alert, the message may be transmitted to a pre-designated destination directly by the hardware platform of the routing/hub functionality software at operation 726.

At decision operation 728, another determination is made whether to perform a local action based on the analysis result. The local action may include instructing an end device to perform a therapeutic action (administration of medication, electric shock, etc.), sounding an audio alert, or similar actions. If the determination is affirmative, the local action(s) may be performed at operation 730. Processing may return to a calling process for further actions after operations 714 or 730.

Any operations performed by the routing/hub functionality software and its associated hardware platforms or other components of a system according to embodiments for managing test and monitoring devices may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least partially on a computing device for managing test and monitoring end devices, the method comprising:
receiving instructions from a data management system;
managing at least one Application Programming Interface (API) for communication with at least one test and monitoring end device;
communicating with the at least one test and monitoring end device based on the instructions received from the data management system;
receiving data from the at least one test and monitoring end device;
transmitting the received data to the data management system;
if additional instructions are received from the data management system in response to the transmitted data associated with the at least one test and monitoring end device, performing actions associated with the at least one test and monitoring end device in response to the additional instructions; and
if further instructions are received from the data management system in response to the transmitted data associated with a configuration of management operations of the at least one test and monitoring end device, modifying the configuration of the management operations in response to the additional instructions.

2. The method of claim 1, further comprising:
determining a hardware environment of a hardware platform comprising one of a custom device and a generic computing device for execution of a software application performing operations of claim 1;
determining a number and type of test and monitoring end devices coupled to the hardware platform;
determining a configuration of each test and monitoring end device coupled to the hardware platform.

3. The method of claim 2, further comprising:
utilizing a communication module of the hardware platform for communicating with at least one of the data management system and the test and monitoring end devices.

4. The method of claim 1, further comprising:
communicating with the at least one test and monitoring end device through one of a radio frequency wireless means, a wired communication means, and an optical communication means; and
communicating with the data management system through at least one from a set of: a wireless public network, a wireless private network, a wired public network, a wired private network, and the Internet.

5. The method of claim 1, further comprising:
performing a preliminary analysis on the received data;
determining whether an alert condition is met based on a result of the analysis; and
if the alert condition is met, transmitting one of: an audio alert, a video alert, a text message, a voice message, and a data upload to a predefined communication end device directly through at least one from a set of: a wireless public network, a wireless private network, a wired public network, a wired private network, and the Internet.

6. The method of claim 1, further comprising:
if a test and monitoring end device without a pre-packaged API is detected, downloading an appropriate API for the detected test and monitoring end device from a predefined network location.

7. The method of claim 1, further comprising:
performing a status check of the at least one test and monitoring end device; and
providing results of the status check to the data management system.

8. The method of claim 1, further comprising:
configuring the at least one test and monitoring end device based on a user profile provided by one of the data management system and the user.

9. The method of claim 1, wherein access to at least one of: the received data and the configuration of the management operations is restricted based on a user profile.

10. The method of claim 1, wherein the at least one test and monitoring end device is a medical condition monitoring device.

11. The method of claim 10, further comprising:
providing instructions to a peripheral device capable of administering one of: a medication and a non-chemical therapeutic action in response to receiving configuration information from the data management system.

12. A computer-readable storage medium with computer-executable instructions stored thereon for managing test and monitoring devices, the instructions comprising:
determining a hardware environment of a hardware platform comprising one of a custom device and a generic computing device for execution of the computer-executable instructions;
determining a number and type of test and monitoring end devices coupled to the hardware platform;
if a test and monitoring end device without a pre-loaded API is detected, downloading an appropriate API for the detected test and monitoring end device from a predefined network location;
receiving instructions for configuring detected test and monitoring devices from a central repository server;
communicating with the test and monitoring end devices through one of a radio frequency wireless means, a wired communication means, and an optical communication means to configure the test and monitoring end devices based on the received instructions and to receive collected data from the test and monitoring end devices; and
transmitting the received data to the central repository server through at least one from a set of: a wireless public network, a wireless private network, a wired public network, a wired private network, and the Internet.

13. The computer-readable storage medium of claim 12, wherein the instructions further comprise:
performing a preliminary analysis on the received data;
determining whether an alert condition is met based on a result of the preliminary analysis; and
if the alert condition is met, causing one of: an audio alert, a video alert, a text message, a voice message, and a data upload to be transmitted to a predefined communication end device through one of the central repository server and directly from the hardware platform.

14. The computer-readable storage medium of claim 12, wherein the instructions further comprise:
communicating with a plurality of detected test and monitoring end devices through wired and wireless means including at least one from a set of: short range RF communication, long range RF communication, infrared optical communication, serial wired communication, and parallel wired communication.

15. The computer-readable storage medium of claim 12, wherein the instructions further comprise:
if a detected test and monitoring end device is capable of communicating through at least two communication modes:
selecting a most appropriate communication mode for initial communication; and
upon detecting a degradation in communication quality, switching to another communication mode.

16. The computer-readable storage medium of claim 12, wherein the instructions further comprise:
if the central repository server is capable of communicating through at least two communication modes:
selecting one of a central repository server prescribed communication mode and a most appropriate communication mode for initial communication; and
upon detecting a degradation in communication quality, switching to another communication mode.

17. The computer-readable storage medium of claim 12, wherein the instructions further comprise:
analyzing the received data locally; and
providing a report to a designated third party through one of a wired and wireless network.

18. A computer-readable storage medium with computer-executable instructions stored thereon for managing a plurality of medical test and monitoring devices, the instructions comprising:
determining a hardware environment of a hardware platform for execution of the computer-executable instructions;
determining a number and type of the medical test and monitoring end devices coupled to the hardware platform through one of: self detection and instructions from a central repository server;
receiving instructions for configuring the coupled medical test and monitoring devices from the central repository server;
communicating with the medical test and monitoring end devices through one of a radio frequency wireless means, a wired communication means, and an optical communication means to configure the medical test and monitoring end devices based on the received instructions and to receive collected data from the medical test and monitoring end devices;
transmitting the received data to the central repository server through at least one from a set of: a wireless public network, a wireless private network, a wired public network, a wired private network, and the Internet such that reports based on analysis of the received data can be provided to third party receivers utilizing preconfigured and customizable templates for common health conditions.

19. The computer-readable storage medium of claim 18, wherein the instructions further comprise:
configuring the medical test and monitoring end devices based on preconfigured and customizable templates for common health conditions received from the central repository server.

20. The computer-readable storage medium of claim 18, wherein the instructions further comprise:
detecting a location of the patient using a location detection module associated with the hardware platform; and
reporting the location of the patient to the central repository server.
